(19) United States
(12) Patent Application Publication
(10) Pub. No.: US 2007/0242830 A1
(43) Pub. Date: Oct. 18, 2007

(54) Anonymous Certificates with Anonymous Certificate Show

(75) Inventors: Claudine Viegas Conrado, Eindhoven (NL); Franciscus Lucas Antonius Johannes Kamperman, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/570,596

(22) PCT Filed: Jun. 25, 2005
(86) PCT No.: PCT/IB05/52039

§ 371 Date: Dec. 14, 2006

(30) Foreign Application Priority Data
Jun. 25, 2004 (EP) 04102970.3

(51) Int. Cl. H04L 9/32

(52) U.S. Cl. 380/285

(57) ABSTRACT

The present invention relates to a method at an issuing authority (111) to anonymously provide an individual (121) with a certificate (C), a method of providing anonymous approval of the individual at a communicating party (101) by means of using the certificate, an issuing authority for anonymously providing an individual with a certificate and an approving device for anonymously approving the individual by means of using the certificate. A basic idea of the invention is to provide an individual anonymously with certificates at an issuing authority, which certificates subsequently can be used by an individual to anonymously prove membership in a group at a communicating party.

The present invention relates to a method at an issuing authority to anonymously provide an individual with a certificate, and a method of providing anonymous approval of the individual at a communicating party by means of using the certificate. The present invention further relates to a certificate for providing anonymous approval of an individual at a communicating party, to an issuing authority for anonymously providing an individual with a certificate and an approving device for anonymously approving the individual by means of using the certificate. Moreover, the present invention relates to an authorization system comprising at least one issuing authority, one approving device and one individual.

There are situations in which a group of individuals, or a sub-group of individuals within the group, has some privilege and membership in the group must be proved to a given first authority to allow any individual in the group to exercise that privilege. An example is that of a group of individuals who may have access to a certain Internet server to which access is controlled. In case the privacy of the individual is of concern, a “membership-proving” transaction, leading to e.g. granted access to the server, may be conducted in anonymous manner such that the first authority does not learn the identity of the individual. This means that the authority must distinguish group members from non-members, but individual members do not need to be distinguished from one another. To achieve this, a number of anonymous group identification schemes have been proposed, in which a group is represented by a publicly known subset of all the public keys of the members of the group. Upon membership verification, neither the individual's secret key nor public key (i.e. the identification of the individual) is revealed to the first authority.

In the scenario described hereinabove, the individual may later wish to prove group membership to a different party, still anonymously, without going through another membership-proving transaction identical to the one that was carried out with the first authority. This may be accomplished by means of a certificate for that membership-proving transaction, which certificate the individual needs to request from the first authority after the transaction is finished. This certificate may contain, in addition to a reference to the individual and the group, data about the transaction, for instance the time at which it happened, the location, the method used in proving the transaction etc. In order to retain the anonymity of the individual, the certificate must be anonymous. Moreover, when full anonymity is required, the anonymity of the certificate should be preserved when the individual later shows the certificate to another party. In “Anonymous Authentication of Membership in Dynamic Groups” by Schechter, Parnell and Hartemink, International Conference on Financial Cryptography '99, British West Indies, 1999, a certificate for the transaction of anonymous proof of membership is proposed. The certificate is issued in a separate protocol with a first authority, after the membership-proving transaction with the first authority is finished. This protocol uses public key encryption and hash functions and states the time at which the transaction was carried out. The certificate is anonymous since it does not reveal the identity of the individual for which it was issued. However, when the individual at any later point of time needs to prove (using the certificate) to another party that he was authenticated by the first authority at a given time, his anonymity is lost. This is because he needs to reveal to that party the certificate itself and a value which only can be calculated by the user and which is used in the certificate, and also his identity (i.e. public key) that is needed in order for the party to be able to verify the values in the certificate.

Digital credential schemes have also been proposed in order for an individual to prove to any party one or more attributes about himself. Such credentials are essentially general-purpose digital certificates issued by an authority. As such, digital credentials can be used as certificates for proof of membership in a group, as defined above. However, in some schemes, even though the anonymity of the individual is kept upon credential presentation, the issuing authority knows the identity of the individual and all the attributes that are bound to that individual, so anonymity is not provided towards the credential issuer. In other schemes, the privacy of the individual is kept upon issuing as well as presentation of the digital credential through the use of pseudonyms. These schemes, however, have the burden of pseudonym management, which has to be performed prior to the credential issuing protocol and is further performed at the individual.

In addition to the issues pointed out in the schemes above, in all of them there is a need to execute two different protocols between the individual and a given authority in order for the individual to obtain a certificate or digital credential attesting group membership. These protocols comprise the protocol in which the individual proves membership in the group and the protocol in which the certificate (or digital credential) itself is issued.

Hence, a problem to be solved in the prior art is how to provide a scheme that: (a) retains the anonymity of the individual upon issuing, as well as presenting, the certificate, (b) executes only one protocol when issuing the certificate and (c) enables only group members to use the certificate subsequently.

An object of the present invention is to solve the above mentioned problem and to provide for an issuing authority to anonymously provide individuals with a certificate which is attained while executing one single protocol. As an additional advantage, it provides for an individual to anonymously prove, to another party, membership in the group by means of the certificate. This should be arranged in a manner such that only group members are able to use the certificates issued by the issuing authority.

This object is attained by means of a method at an issuing authority to anonymously provide an individual with a certificate in accordance with claim 1, a certificate for providing anonymous approval of an individual at a communicating party in accordance with claim 12, a method of providing anonymous approval of an individual at a communicating party by means of using a certificate in accordance with claim 13, an issuing authority for anonymously providing an individual with a certificate in accordance with claim 16, an approving device for anonymously approving the individual by means of using a certificate in accordance with claim 26 and an authorization system comprising at least one issuing authority, one approving device and one individual in accordance with claim 29.

According to a first aspect of the invention, there is provided a method at an issuing authority to anonymously provide an individual with a certificate, which method comprises the steps of receiving, at said issuing authority from the individual, a plurality of data structures that each comprises a value based on an identifier pertaining to the individual, and at least one encrypted copy of the identifier; sending, from said issuing authority to the individual, a request to attain a first number of the identifiers that were included in the data structures received at the issuing authority; receiving, at said issuing authority from the individual, said first number of the identifiers and the encryption key that corresponds to each said at least one encrypted copy of the identifier; verifying, at said issuing authority, that the corresponding encryption key is included in a predetermined set of keys held by the issuing authority and that said at least one encrypted copy of the identifier has been encrypted with said corresponding encryption key comprised in the set, and sending a confirmation thereof to the individual; receiving, at said issuing authority from the individual, at least one of the number of remaining encrypted identifiers comprised in the plurality of data structures and verifying, for each value based on a corresponding remaining identifier, that said at least one remaining encrypted identifier can be identified from the plurality of data structures. The method further comprises the step of issuing, at said issuing authority, for each said at least one of the remaining encrypted identifiers, a certificate that comprises the respective said at least one remaining encrypted identifier and the corresponding value based on that remaining encrypted identifier, which certificate indicates that it has been issued by a trusted issuing authority.

According to a second aspect of the invention, there is provided a certificate for providing anonymous approval of an individual at a communicating party, which certificate comprises a value based on an identifier pertaining to the individual which is in possession of the certificate, an encrypted copy of the identifier and an indication that the certificate has been issued by a trusted issuing authority.

According to a third aspect of the invention, there is provided a method of providing anonymous approval of an individual at a communicating party by means of using a certificate, which method comprises the steps of receiving, at the communicating party, a certificate of the individual; verifying, at the communicating party, that the certificate has been issued by a trusted issuing authority; sending, from the communicating party to the individual, the encrypted identifier included in the certificate; and receiving, at the communicating party, proof that the individual knows the identifier.

According to a fourth aspect of the invention, there is provided an issuing authority for anonymously providing an individual with a certificate, the issuing authority being arranged with receiving means for receiving, from the individual, a plurality of data structures that each comprises a value based on an identifier pertaining to the individual, and at least one encrypted copy of the identifier; transmitting means for transmitting, to the individual, a request to attain a first number of the identifiers; wherein said receiving means is further arranged to receive, from the individual, said first number of the identifiers and the encryption key corresponding to each said at least one encrypted copy of the identifier. The issuing authority is further arranged with verifying means for verifying that the corresponding encryption key is included in a predetermined set of keys held by the issuing authority and that said at least one encrypted copy of the identifier has been encrypted with said corresponding encryption key comprised in the set, and for sending a confirmation thereof to the individual; wherein said receiving means is further arranged to receive, from the individual, at least one of the number of remaining encrypted identifiers comprised in the plurality of data structures; and said verifying means is further arranged to verify, for each value based on a corresponding remaining identifier, that said at least one remaining encrypted identifier can be identified from the plurality of data structures; and which issuing authority further is arranged with issuing means for issuing, for each said at least one of the remaining encrypted identifiers, a certificate that comprises the respective said at least one remaining encrypted identifier and the corresponding value based on that remaining encrypted identifier, which certificate indicates that it has been issued by a trusted issuing authority.

According to a fifth aspect of the invention, there is provided an approving device for anonymously approving an individual by means of using a certificate, which approving device is arranged with receiving means for receiving a certificate of the individual; verifying means for verifying that the certificate has been issued by a trusted issuing authority; sending means for sending, to the individual, the encrypted identifier included in the certificate; and wherein said receiving means is further arranged to receive proof that the individual knows the identifier.

According to a sixth aspect of the invention, there is provided an authorization system comprising at least one issuing authority, one approving device and one individual, wherein the authorization system is arranged such that the issuing authority anonymously provides the individual with a certificate, and the approving device anonymously approves the individual by means of using the certificate.

A basic idea of the present invention is to send, from an individual to an issuing authority such as a server connected to the Internet, a request to anonymously receive a certificate issued by the issuing authority. Hence, the communication channel established between the individual and the issuing authority must be anonymous so that the issuing authority cannot acquire the identity of the individual, for example the IP address of the individual. Note that this anonymous channel need not be secret, since no secret information is exchanged. The term “individual” does not necessarily mean an individual person, but may suggest an individual device, such as a mobile phone, a PDA, a laptop, a portable audio player or some other appropriate device having computing and communicating capabilities. The term individual device may also suggest e.g. a smart-card or some other tamper-resistant appliance included in a device such as a mobile phone. Further, it should be understood that an intermediate device, for example a server provided by a service provider, can be arranged to relay the information between the individual and the issuing authority, or even be arranged to relay the information between a plurality of individuals and the issuing authority. In that case, the term individual may also comprise the intermediate device itself, and it is necessary that at least the communication between the individual(s) and the intermediate device is anonymous.

The issuing authority receives the request in the form of a plurality M of data structures that each comprises a value based on an identifier associated with the individual and at least one encrypted copy of the identifier. As will be shown in the following, it is preferred that a number S of encrypted copies of the identifier is comprised in each data structure, wherein each copy is encrypted with a different key. The different keys that are used belong to a predetermined set of keys held by the issuing authority. Upon receiving the request, the issuing authority chooses a first number M-B of the data structures M for which the individual will reveal the corresponding identifier and the encryption key(s) corresponding to each encrypted identifier received at the issuing authority. The individual thereafter sends the chosen identifiers and the encryption keys to the issuing authority. The issuing authority verifies that these encryption keys are included in the predetermined set of keys held by the issuing authority, and that the encrypted copies of the identifier have been encrypted with a valid corresponding encryption key and sends a confirmation thereof to the individual.

When the confirmation is received by the individual, at least one of the number B of remaining values based on an identifier associated with the individual and at least one of the number B*S of remaining encrypted identifiers comprised in the plurality M of data structures is sent to the issuing authority. The issuing authority can thus issue, if the remaining encrypted identifiers can be identified from the plurality M of data structures, a certificate for that remaining encrypted identifier, which certificate indicates that the encryption key of the remaining encrypted identifier is comprised in said predetermined set known by the issuing authority. Thus, the certificate indicates that the individual whose encryption key is employed to encrypt the identifier complies with a “group membership” requirement of the trusted issuing authority. Since every generated remaining identifier preferably should be employed to create a corresponding certificate, the issuing authority preferably receives the complete number B of remaining encrypted identifiers and generates a certificate for each remaining encrypted identifier. That is, the number of certificates typically equals the number B of remaining encrypted identifiers. Each certificate comprises the respective remaining encrypted identifier and the corresponding value based on that remaining encrypted identifier.

The present invention is advantageous, since the certificate is anonymous due to the fact that the identity of the individual, i.e. the encryption key used to encrypt the identifier in the certificate, is not revealed. Also, the reference to the predetermined set of keys held by the issuing authority, i.e. the reference to the group to which the certificate states that the individual belongs, is made via the issuing authority which approves the certificate. It is thereby assumed that a specific issuing authority only issues certificates referring to a specific group. Since the individual sends all the encryption keys used to encrypt the identifiers to the authority, the authority is capable of verifying, for every data structure included in the plurality M, that only valid keys, i.e. encryption keys contained in the predetermined set of keys held by the issuing authority, were used to encrypt the identifiers. Thereby, the issuing authority is confident that the remaining encrypted identifiers which were comprised in the plurality M of data structures also have been encrypted with valid encryption keys. As mentioned hereinabove, to take full advantage of the generated identifiers, the number of issued certificates typically equals the number B of unconcealed, remaining encrypted identifiers. For the batch B of certificates issued, linkability with respect to the identifiers is avoided since each certificate is issued with a different identifier. The individual can subsequently prove, to a party, knowledge of the encrypted identifier included in the certificate, without revealing the identifier itself, by using a decryption key that is only known by the individual to obtain the identifier from the certificate. Typically, an asymmetric key pair (a public key and a private key) is employed in the encryption/decryption procedure. The proof of knowledge of the identifier is typically provided by means of a zero-knowledge protocol. This has the effect that a communicating party, i.e. an approving device, to which the certificate is shown, is not able to use the certificate to masquerade as the individual to some other party.

When the individual anonymously is approved at a communicating party by means of the certificate, the communicating party receives the certificate from the individual and verifies that the certificate has been issued by a trusted issuing authority. The communicating party sends the encrypted identifier to the individual which subsequently proves knowledge of the identifier in a zero-knowledge protocol. The decryption key, which is only known by the individual, is used to obtain the plaintext identifier. The value based on the identifier is used by the communicating party for checks during the execution of the protocol. The communication channel established between the individual and the communicating party must be anonymous so that the communicating party cannot acquire the identity of the individual.

As can be realized from the description hereinabove, there are two parameters which can be adjusted to control the levels of security and anonymity. These parameters also determine the efficiency of the method according to the present invention in relation to computational, storage and information exchange resources of the parties involved. These two parameters are (a) the number M of identifiers that the individual must generate and (b) the number S of encryption keys that is used to provide the data structures with a corresponding number S of encrypted copies of the identifiers.

The parameter M, where M>1, is the security parameter which in principle is set by the issuing authority. The greater the value of M, the higher the confidence of the issuing authority that the number B of remaining encrypted identifiers comprised in the plurality M of data structures has been encrypted with valid encryption keys, i.e. encryption keys contained in the predetermined set of keys held by the issuing authority. Typically, the issuing authority can handle a great number of computations. However, the individual may find it burdensome to calculate, store and send a large number of data structures. Hence, the security aspect at the issuing authority must be balanced against the computations undertaken on the individual side.

The parameter S, where 1<S≦N (where N=the total number of keys in the predetermined set), is the anonymity parameter which is set by the individual. The number S of encryption keys that is used to provide the issuing authority with a corresponding number S of encrypted copies of the identifiers includes the encryption key pertaining to the particular individual. The greater the value of S, the more anonymous the encryption key of the individual is in the specific predetermined set of keys (and thereby the more anonymous the individual per se is). Again, a trade-off must be made; the number of encryptions of identifiers on the individual side must be weighed against the anonymity aspect at the issuing authority. Note that once the certificates have been issued, it is no longer necessary to store the identifiers at the individual.

However, note that since proof of group membership does not happen at the time of certificate issuance, the protocol for certificate issuance can be carried out between the issuing authority and any party. This party must know the set of keys of the group and must act on the behalf of one or more individuals of the group so as to obtain a number B of certificates when engaging in the protocol with the issuing authority. Each of these B certificates comprises a remaining encrypted identifier and the corresponding value based on that remaining encrypted identifier. Moreover, this party has preferably large computational capabilities so as to eliminate the computational restrictions that may exist at the individual.

According to embodiments of the present invention, each identifier comprises secret random information generated at the individual and the respective value based on an identifier comprises an exponential function, also calculated at the individual, of the corresponding secret random information. This is advantageous, since the secret random information can be chosen from a group of numbers in which computation of roots is a difficult problem. For instance, the value based on an identifier can thus be expressed as the secret random information raised to two, in accordance with the Fiat-Shamir protocol. Alternatively, the value can be expressed as the secret random information raised to a factor p, where p is a prime, in accordance with the Guillou-Quisquater protocol.

According to another embodiment of the present invention, the indication that the certificate has been issued by a trusted issuing authority is accomplished by providing each certificate with a signature of the issuing authority. Hence, the integrity of the certificate can be verified by verifying the correctness of the signature at a communicating party. As previously described, the trusted issuing authority chooses a first number M-B of the data structures M for which the individual will reveal the respective identifier and the encryption keys corresponding to the respective encrypted identifier received at the issuing authority. If the first number M-B is sufficiently high, the authority can be confident that the number B of unconcealed, remaining encrypted identifiers (which number typically equals the number of issued certificates) also has been encrypted with keys that are included in the predetermined set of keys held by the issuing authority. Hence, the signature of the issuing authority in any given certificate corresponding to a given unconcealed, remaining encrypted identifier can be seen as an assurance that the key that is used to encrypt the unconcealed, remaining encrypted identifier is indeed included in the predetermined set of keys held by the issuing authority. Thus, the signature indicates that the individual, who subsequently is able to prove knowledge of the random identifier in the certificate, complies with the group membership requirement of the trusted issuing authority, i.e. he is a member of the group.

According to yet another embodiment of the invention, each certificate further comprises data related to the issuing of the certificate. This data can, for example, relate to the time of issuing of the certificate in the form of a time stamp, the method used to provide the proof, the location where the certificate was issued etc. The communicating party is ensured that the public key belongs to the group according to said data. For instance, it belonged to the group at an earlier instant in time. If being part of a group entitles an individual to some privilege that the party can grant and the members of the group have not changed since that particular instant in time, the individual can exercise that privilege anonymously.

According to a further embodiment of the invention, the time stamp is provided such that, if more than one certificate is issued to the individual, each certificate comprises a time stamp which differs from the time stamp of any of the other certificates issued to the individual. In case more than one certificate is issued to the individual in a batch B of certificates (which are all issued at the same time), each certificate then comprises a time stamp which differs by a random small amount from the time stamp of any of the other certificates issued to the individual.

This embodiment is advantageous, since the risk of having an intruder succeeding in linking one certificate to another is reduced. Any particular time stamp included in the batch B of issued certificates differs from any other time stamp included in the batch. Since the values of the time stamps differ, one time stamp cannot be directly linked to another. With a first certificate, the individual may anonymously prove membership in a group to a communicating party. If the same communicating party again is anonymously contacted by the same individual and a second certificate from the same batch is shown to the communicating party, the values of the time stamps differ, and thus the party cannot be sure that the two certificates relate to the same individual.

Further features of, and advantages with, the present invention will become apparent when studying the appended claims and the following description. Those skilled in the art realize that different features of the present invention can be combined to create embodiments other than those described in the following.

The preferred embodiments of the present invention will be described in detail with reference made to the accompanying drawings, in which:

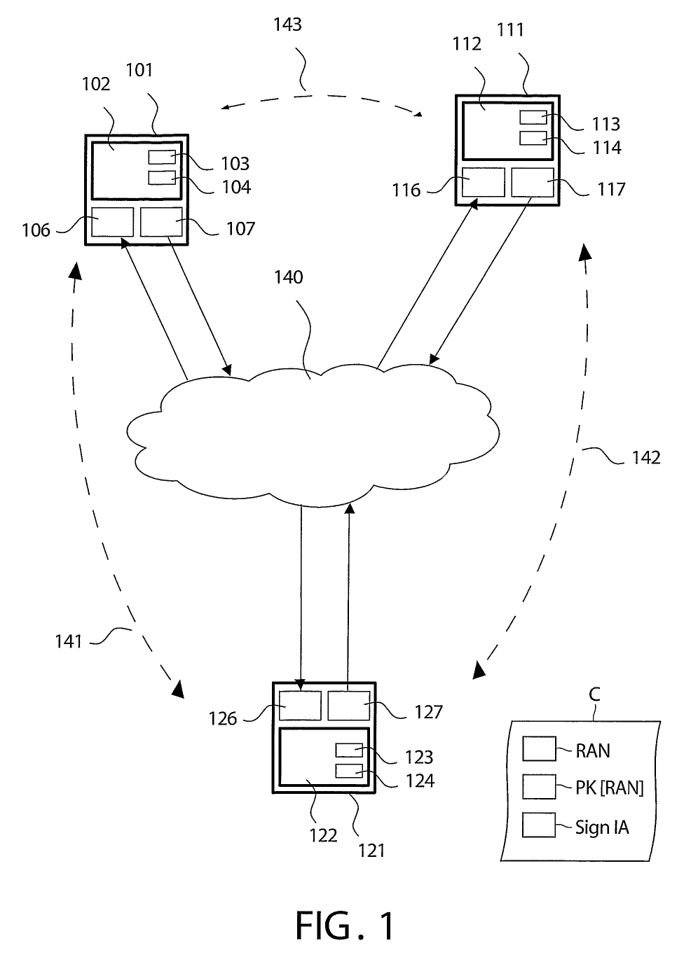

FIG. 1 shows an authorization system according to the present invention, in which system the aspects of present invention may be embodied;

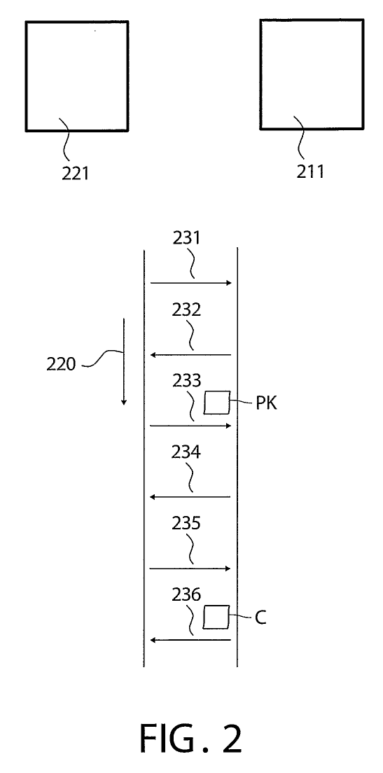

FIG. 2 shows a certificate issuing protocol in which a user device and a trusted certificate issuing authority is engaged; and

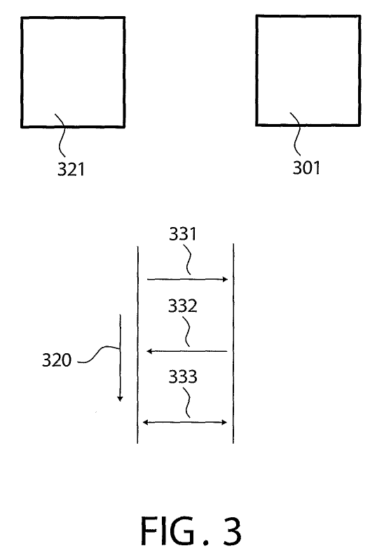

FIG. 3 shows a certificate approval protocol in which a user device and a communicating party is engaged.

FIG. 1 shows an authorization system according to the present invention, in which system the aspects of present invention may be embodied. Shown is an “individual” in the form of a user device 121, which can for example be a smart card or a USB dongle arranged in a device such as a mobile phone, a PDA, a laptop, a portable audio player or some other appropriate device having computing and communicating capabilities. Further shown is a trusted issuing authority 111 for issuing certificates and a communicating party 101 (i.e. an approval device) at which the certificate is used for providing anonymous approval of the user device. Typically, a system as shown in FIG. 1 comprises a plurality of user devices and communicating parties. It may also comprise a number of issuing authorities. To illustrate the fact that communication is effected between different devices, the terms “user device” and “communicating party” will be employed throughout the description. However, the communicating party typically comprises a user device similar to the device that is denoted by 121 and has similar properties.

The devices (user device-issuing authority and user device-communicating party) may be interconnected via a network 140, for example the Internet, but can also be interconnected directly as illustrated via communication channels 141 and 142. Since the communicating party 101 typically comprises a user device, the communicating party may analogously be interconnected with the issuing authority via communication channel 143. The computing capabilities are typically embodied by a processing unit 102, 112, 122 in the respective device. The processing units comprise a processor 103, 113, 123, a memory 104, 114, 124 and possibly other necessary standard electronic equipment. The processing units handle e.g. encryption/decryption functionality. Each of the devices 101, 111, 121 are arranged with receiving means 106, 116, 126 for receiving information from the network or from other devices and transmitting means 107, 117, 127 for transmitting information.

The devices comprised in the system assumed to be compliant. This means that these devices comply with a given standard and adhere to certain operation rules. It also means that the devices communicates by means of a certain protocol such that they answer questions and requests, which are posed to them, in the expected way. Even though the invention has been described with reference to specific exemplifying embodiments thereof, many different alterations, modifications and the like will become apparent for those skilled in the art. The described embodiments are therefore not intended to limit the scope of the invention, as defined by the appended claims. Note that the skilled man realizes that the processing units 102, 112, 122 in the respective device 101, 111, 121 comprised in the present invention typically executes appropriate software to perform the steps as described in connection to FIG. 2-3.

When a user device 121 wants to have a certificate issued anonymously, the user device must, via an anonymous channel such that no identification data for the user device (i.e. the individual) is revealed, contact the issuing authority 111.

In an embodiment of the invention, the following format for the anonymous certificate is proposed:
C={RAN²,PK[RAN]}_{SignIA}, (1),
where
RAN is a secret random number generated at the user device, RAN is in the following referred to as the identifier of the user device;
PK is the public key of the user device;
PK[RAN] is the encryption of RAN with PK; and
SignIA is the signature of the issuing authority attached to the certificate.

The well-known Fiat-Shamir identification protocol can be used to prove to the communicating party 101, upon presenting the certificate C to this party, the knowledge of the secret random number RANεZₙ*, whose square value RAN² is available to the communicating party from the certificate. This problem is based on the fact that computing square roots in the multiplicative group Zₙ*, is a hard problem. In applications were communication cost is an issue, for example if the user device is implemented using a smart card, the Guillou-Quisquater identification protocol is more suited, with higher powers of RAN (RAN^{p}, where p is a prime), since exchanges between the user device and the communicating party can be kept to a minimum. The value RAN is a different randomly chosen value in Zₙ* for each certificate, so the value RAN² is also unique per certificate. The user device encryption key PK, however, which is the same for all certificates of a given user, is not in the clear. Because only the user has access to the private key SK corresponding to the public key PK, only the user can retrieve RAN from the certificate C. The certificate must be signed by the trusted issuing authority (which for example can be a content provider) in order for the communicating party be sure of its integrity.

Note that it is not necessary to keep the RAN-values in storage in the user device. The step of user authentication happens implicitly when the user device retrieves the value RAN, for only a user who knows the private key SK, corresponding to the user public key PK, is able to decrypt PK[RAN] to obtain the value RAN.

The communication protocol used in the present invention between the user device and the issuing authority is typically of the cut and choose type. That is, the user device generates a number of secret values which are calculated according to a specific procedure. A secret that is calculated according to this given procedure can only be verified if the secret is revealed. Therefore, the issuing authority chooses, at random, a number of these secret values, which values the user device reveals to the issuing authority. If at least one of these values has not been calculated according to the given procedure, the issuing authority refuses all other values and the protocol finishes. If, on the other hand, all of these values have been calculated according to the given procedure, the issuing authority can be confident that the unrevealed secret values also have been calculated in accordance with the given procedure.

Now, based on the cut and choose concept, the user device 121 anonymously contacts the issuing authority 111, and in order to have one single certificate issued, the individual generates a number M of secret random numbers RAN (RANₘ, where m=1, 2, . . . , M). Next, the user device chooses S public keys comprised in the predetermined set P held by the issuing authority to form a set P_{R}. The set P_{R} may be the complete predetermined set P, in which case S=N, or a subset of P in case N is very large. However, the set P_{R} must include the public key PK_{ind} of this specific user device. The user device then calculates PKₛ[RANₘ] for all keys in the set P_{R} (i.e. s=1, 2, . . . , S) and for all M (i.e. m=1, 2, . . . , M) values of RAN.

As previously mentioned, the parameter M, where M>1, is the security parameter which in principle is set by the issuing authority. The greater the value of M, the higher the confidence of the issuing authority that the identifiers (i.e. the respective RAN) have been encrypted with valid encryption keys, where “valid” encryption keys are those contained in the predetermined set of keys held by the issuing authority.

The parameter S, where 1<S≦N, is the anonymity parameter which is set by the individual. The greater the value of S, the more anonymous the encryption key PK_{ind} of the individual is in the specific predetermined set P of keys (and thereby the more anonymous the individual per se is).

With reference made to FIG. 2, which illustrates an issuing protocol along a timeline 220 between a user device 221 and a trusted certificate issuing authority 211, the user device then sends to the issuing authority a number M of data structures of the form:
[RANₘ²,{PKₛ[RANₘ], s=1, 2, . . . , S}]
that is, the issuing authority receives, at step 231, the plurality M of data structures that each comprises a value RANₘ² based on an identifier RANₘ pertaining to the user device, and at least one encrypted copy PKₛ[RANₘ] of the identifier. In practice, as mentioned hereinabove, a number of encrypted copies of the identifier is included in each data structure. The issuing protocol provides anonymity for the user device towards the issuing authority. On receiving the data structures, the issuing authority chooses, at step 232, M-B of the identifiers. This choice may be done by communicating, to the user device, the plurality M-B of values RANₘ² that corresponds to the (plurality M-B of) identifiers RANₘ which the issuing authority chooses. Another way to effect the choice is to number all data structures in sequence, and have the issuing authority communicate its choice by sending a message that indicates which ones of the data structures the issuing authority wishes to receive. Hence, a number B of the identifiers RANₘ is kept secret and will subsequently be used in the issued certificates.

At step 233, the chosen data, i.e. the number M-B of identifiers RANₘ and all encryption keys PKₛ comprised in the set P_{R}, is sent to the issuing authority. The issuing authority verifies that the encryption keys are included in the predetermined set P, i.e. that the encryption keys used to encrypt the identifiers are valid, and also verifies that each one of the values PKₛ[RANₘ] for each of the M-B revealed RANₘ values is correct. The authority can verify that the values PKₛ[RANₘ] for the M-B data structures that correspond to the chosen data indeed have been encrypted with valid keys by encrypting each chosen identifier RANₘ with the corresponding encryption key PKₛ comprised in the set P_{R}.

If this fact is confirmed, the issuing authority can be confident that the data structures with the undisclosed identifiers was encrypted with valid encryption keys, i.e., encryption keys in the set P_{R}. The issuing authority sends, at step 234, a confirmation thereof to the user device. Note that the set P_{R} must include the public key PK_{ind} of the user device so this key is preferably chosen to be one and the same for all M data structures. Moreover, since the set P_{R} preferably is a large set (at least larger than 1, as anonymity relies on the fact that the key of the user device is comprised in the set, and hence among many other keys). In this preferable case, the keys PKₛ in the set P_{R} are sent only once to the issuing authority since they are the same for all data structures.

At step 235, the user device sends the remaining number B of encrypted identifiers PK_{ind}[RANₘ], which respective encrypted identifier is to be used in the issued certificates, to the issuing authority. The issuing authority checks that PK_{ind}[RANₘ] appears in the data structures that was received previously, creates a certificate C and signs the certificate in accordance with (1). Finally, at step 236, the certificate is sent to the user device. The certificate can subsequently only be used by a group member—i.e. an individual who owns one of the public keys in the predetermined set P—who knows the private key SK_{ind} that corresponds to the public key PK_{ind}.

Anyone who has access to the set P may have a certificate issued for public key(s) comprised in the set, since the proof of knowledge of the private key is not provided during the execution of the protocol. For instance, a third party that is trusted by the individual and which could perform a certificate issuing service for the individual at a given fee. This third party is comparable with the previously mentioned intermediate device arranged to relay information between the individual and the issuing authority. The communication between the individual and the intermediate device must be anonymous. However, there are no requirements on anonymity between the intermediate device and the issuing authority.

According to another embodiment of the invention, each certificate further comprises data related to the issuing of the certificate. This data can, for example, relate to the time of issuing of the certificate in the form of a time stamp T, as shown in (2) below:
C={RAN²,PK[RAN],T}_{SignIA}, (2)

If being part of a group entitles an individual to some privilege that the party can grant and the members of the group have not changed since that particular instant in time, the individual can exercise that privilege anonymously. The time stamp may be provided such that, if more than one certificate is issued in a batch to the individual, each certificate in this batch comprises a time stamp which differs from the time stamp of any of the other certificates issued to the individual.

FIG. 3 illustrates an approval protocol along a timeline 320 between a user device 321 and a communicating party 301. When the user device 321 wishes to anonymously prove membership to the communicating party 301, the user device establishes contact via an anonymous channel. At step 331, the user device sends a certificate to the communicating party over the anonymous channel. The communicating party verifies that the certificate has been issued by a trusted issuing authority by means of the public key that corresponds to the private key of the issuing authority, which private key was employed to provide the certificate with the digital signature SignIA.

Then, at step 332, the communicating party sends the encrypted identifier PK[RAN] that is included in the certificate—which e.g. may be in the form as described in (1) or (2)—back to the user device. The identifier is, by means of decrypting the encrypted identifier with the private key SK that corresponds to the public key PK, obtained in plain text at the user device. Finally, at step 333, the communicating party receives proof that the user device knows the identifier RAN that was comprised in the certificate. As mentioned earlier, the proof is provided by means of a zero-knowledge protocol between the user device and the communicating party. This means that after the zero-knowledge protocol, the communicating party is convinced that the user device knows the identifier RAN (that only that user device could know), but nothing is revealed to the communicating party about that identifier. This prevents the communicating party from impersonating the user device by showing knowledge of the value RAN in a transaction with yet another communicating party. During the zero-knowledge protocol, there are a number of rounds, and in each round, the confidence of the communicating party increases, given the fact that the user device actually knows the identifier RAN. If the communicating party is sufficiently convinced that the user device knows the identifier RAN, it acts accordingly. If the communicating party acts as content device, it can give the user access to digital content in the form of, for example, MPEG or MP3 files or other audio and/or video content. In another embodiment, the communicating party can communicate the results to a different device operating as content device. With the procedure described in connection to FIG. 3, the communicating party 301 can be confident that the anonymous individual 321 knows the private (secret) key that corresponds to the public key that is used to encrypt the identifier, which encrypted identifier is contained in the certificate. Moreover, the signature of the issuing authority on the certificate guarantees that the public key that is used to encrypt the identifier indeed belongs to a group which is known and certified by that issuing authority. However, the communicating party does not learn anything about that public key.

Even though the invention has been described with reference to specific exemplifying embodiments thereof, many different alterations, modifications and the like will become apparent for those skilled in the art. The described embodiments are therefore not intended to limit the scope of the invention, as defined by the appended claims.

1. A method at an issuing authority (111) to anonymously provide an individual (122) with a certificate (C), the method comprising the steps of:
receiving (231), at said issuing authority from the individual, a plurality (M) of data structures that each comprises a value based on an identifier (RAN) pertaining to the individual, and at least one encrypted copy (PK[RAN]) of the identifier;
sending (232), from said issuing authority to the individual, a request to attain a first number (M-B) of the identifiers (RAN) that were included in the data structures received at the issuing authority;
receiving (233), at said issuing authority from the individual, said first number (M-B) of the identifiers and the encryption key (PK) that corresponds to each said at least one encrypted copy of the identifier;
verifying, at said issuing authority, that the corresponding encryption key (PK) is included in a predetermined set (P) of keys held by the issuing authority and that said at least one encrypted copy of the identifier has been encrypted with said corresponding encryption key comprised in the set, and sending (234) a confirmation thereof to the individual;
receiving (235), at said issuing authority from the individual, at least one of the number (B) of remaining encrypted identifiers comprised in the plurality (M) of data structures and verifying, for each value based on a corresponding remaining identifier, that said at least one remaining encrypted identifier can be identified from the plurality (M) of data structures;
issuing (236), at said issuing authority, for each said at least one of the remaining encrypted identifiers, a certificate that comprises the respective said at least one remaining encrypted identifier and the corresponding value based on that remaining encrypted identifier, which certificate indicates that it has been issued by a trusted issuing authority.

2. The method according to claim 1, wherein each identifier comprises secret random information (RAN).

3. The method according to claim 2, wherein the respective values based on an identifier (RAN) comprise an exponential function of the corresponding secret random information.

4. The method according to claim 3, wherein the exponent is a prime (p).

5. The method according to claim 1, wherein each certificate (C) further comprises data related to the issuing of the certificate.

6. The method according to claim 5, wherein said data related to the issuing of the certificate comprises a time stamp (T) indicating the time of issuing of the certificate (C).

7. The method according to claim 6, wherein said time stamp (T) is provided such that, if more than one certificate (C) is issued to the individual (121), each certificate comprises a time stamp which differs from the time stamp of any of the other certificates issued to the individual.

8. The method according to claim 1, wherein the indication that the certificate (C) has been issued by a trusted issuing authority (111) is accomplished by providing each certificate with a signature (SignIA) of the issuing authority.

9. The method according to claim 1, wherein each identifier (RAN) is encrypted with a corresponding public key (PK) comprised in said predetermined set (P) of keys.

10. The method according to claim 9, wherein a number (S) of encrypted copies (PKₛ[RAN]) of the identifier is included in each data structure, each identifier being encrypted with a different public key comprised in said predetermined (P) set of keys.

11. The method according to claim 1, wherein said values and identifiers (RAN) are generated at the individual (121).

12. A certificate (C) for providing anonymous approval of an individual (121) at a communicating party (101), which certificate comprises:
a value based on an identifier (RAN) pertaining to the individual which is in possession of the certificate;
an encrypted copy (PK[RAN]) of the identifier; and
an indication (SignIA) that the certificate has been issued by a trusted issuing authority (111).

13. A method of providing anonymous approval of an individual (121) at a communicating party (101) by means of using a certificate (C) in accordance with claim 12, the method comprising the steps of:
receiving (331), at the communicating party, a certificate of the individual;
verifying, at the communicating party, that the certificate has been issued by a trusted issuing authority (111);
sending (332), from the communicating party to the individual, the encrypted (PK[RAN]) identifier included in the certificate; and
receiving (333), at the communicating party, proof that the individual knows the identifier.

14. The method according to claim 13, wherein the identifier (RAN) is obtained at the individual (121) by decrypting the encrypted (PK[RAN]) identifier by means of the corresponding decryption key (SK).

15. The method according to claim 13, wherein the proof that the individual (121) knows the identifier (RAN) is provided by employing a zero-knowledge protocol.

16. An issuing authority (111) for anonymously providing an individual (121) with a certificate (C), the issuing authority being arranged with:
receiving means (116) for receiving (231), from the individual, a plurality (M) of data structures that each comprises a value based on an identifier (RAN) pertaining to the individual, and at least one encrypted copy (PK[RAN]) of the identifier;
transmitting means (117) for transmitting (232), to the individual, a request to attain a first number (M-B) of the identifiers; wherein
said receiving means is further arranged to receive (233), from the individual, said first number (M-B) of the identifiers and the encryption key (PK) corresponding to each said at least one encrypted copy of the identifier;
verifying means (112) for verifying that the corresponding encryption key is included in a predetermined set (P) of keys held by the issuing authority and that said at least one encrypted copy of the identifier has been encrypted with said corresponding encryption key comprised in the set, and for sending (234) a confirmation thereof to the individual; wherein
said receiving means is further arranged to receive (235), from the individual, at least one of the number (B) of remaining encrypted identifiers comprised in the plurality (M) of data structures; and
said verifying means is further arranged to verify, for each value based on a corresponding remaining identifier, that said at least one remaining encrypted identifier can be identified from the plurality (M) of data structures; and which issuing authority further is arranged with
issuing means (112) for issuing (236), for each said at least one of the remaining encrypted identifiers, a certificate that comprises the respective said at least one remaining encrypted identifier and the corresponding value based on that remaining encrypted identifier, which certificate indicates that it has been issued by a trusted issuing authority.

17. The issuing authority (111) according to claim 16, wherein each identifier is arranged to comprise secret random information (RAN).

18. The issuing authority (111) according to claim 17, wherein the respective value based on an identifier (RAN) is arranged to comprise an exponential function of the corresponding secret random information.

19. The issuing authority (111) according to claim 18, wherein the exponent is arranged to be a prime (p).

20. The issuing authority (111) according to claim 16, wherein each certificate (C) further is arranged to comprise data related to the issuing of the certificate.

21. The issuing authority (111) according to claim 20, wherein said data related to the issuing of the certificate is arranged to comprise a time stamp (T) indicating the time of issuing of the certificate (C).

22. The issuing authority (111) according to claim 21, wherein said time stamp (T) is provided such that, if more than one certificate (C) is issued to the individual (121), each certificate is arranged to comprise a time stamp which differs from the time stamp of any of the other certificates issued to the individual.

23. The issuing authority (111) according to claim 16, wherein the indication that the certificate (C) has been issued by a trusted issuing authority (111) is accomplished by arranging each certificate with a signature (SignIA) of the issuing authority.

24. The issuing authority (111) according to claim 16, wherein each identifier (RAN) is arranged to be encrypted with a corresponding public key (PK) comprised in said predetermined set (P) of keys.

25. The issuing authority (111) according to claim 24, wherein a number (S) of encrypted copies (PKₛ[RAN]) of the identifier is arranged to be included in each data structure, each identifier being encrypted with a different public key comprised in said predetermined (P) set of keys.

26. An approving device (101) for anonymously approving an individual (121) by means of using a certificate (C) in accordance with claim 12, the approving device being arranged with:
receiving means (107) for receiving (331) a certificate of the individual;
verifying means (102) for verifying that the certificate has been issued by a trusted issuing authority (111);
sending means (106) for sending (332), to the individual, the encrypted (PK[RAN]) identifier included in the certificate; and wherein
said receiving means is further arranged to receive (333) proof that the individual knows the identifier.

27. The approving device (101) according to claim 26, wherein the identifier (RAN) is arranged to be obtained at the individual (121) by decrypting the encrypted (PK[RAN]) identifier by means of the corresponding decryption key (SK).

28. The approving device (101) according to claim 26, wherein the proof that the individual (121) knows the identifier (RAN) is arranged to be provided by employing a zero-knowledge protocol.

29. An authorization system comprising at least one issuing authority (111), one approving device (101) and one individual (121), wherein the authorization system is arranged such that the issuing authority anonymously provides the individual with a certificate (C), and the approving device anonymously approves the individual by means of using the certificate.
